(19) United States
(12) Patent Application Publication
(10) Pub. No.: US 2004/0078244 A1
(43) Pub. Date: Apr. 22, 2004

(54) Sector selection investment option in a variable insurance product

(76) Inventor: Mitchell R. Katcher, Stamford, CT (US)

Correspondence Address: SAGE GROUP INSURANCE, INC. (DELAWARE CORPORT-, ION), 300 ATLANTIC STREET THIRD FLOOR, STAMFORD,, CT, 06901, US

(21) Appl. No.: 10/273,941

(22) Filed: Oct. 18, 2002

(51) Int. Cl. G06F 17/60

(52) U.S. Cl. 705/4

(57) ABSTRACT

The present invention provides a combination of the investment methodology known as sector rotation with tax-advantaged investment products, particularly, variable annuity and variable life insurance products and combination insurance products. The sector rotation methodology is implemented through purchase of appropriate funds, such as equity mutual funds, exchange traded funds, or index funds which are available through such variable annuity and variable life insurance products and combination insurance products, and such funds being determined by an asset allocation or style-driven model created by an insurance company or investment adviser. In one embodiment, the sector rotation methodology is implemented through a fund of funds approach.

### FIELD OF THE INVENTION

The present invention relates to the field of financial products and methods used in connection with retirement income planning and investing.

### BACKGROUND OF THE INVENTION

An annuity contract in its simplest form is a contract between an insurance company and a contract owner that provides for payments to an annuity beneficiary at regular intervals during the life of a specified individual, the annuitant. Annuities play a significant role in a variety of contexts, including life insurance, disability insurance, and pensions. For example, life insurance may be purchased by making premium payments with the lifetime income payments provided by an annuity instead of by a single premium. In many cases, the proceeds of a life insurance policy payable upon the death of the insured may be converted through a settlement option into an annuity for the beneficiary. An annuity may be used to provide periodic payments to a disabled worker for so long as the worker is disabled. Retirement plan contributions may be used to purchase immediate or deferred annuities payable during retirement.

A life insurance policy in its simplest form is a contract between an insurance company and a policy owner that provides for payment of a death benefit upon the death of a specified individual, the insured. Life insurance plays a significant role in a variety of contexts.

Life insurance products and annuity products (together, “insurance products”) are considered tax-advantaged investment products because the United States Internal Revenue Code (the “Code”) generally allows for deferral of income taxes on investment growth until the time that the earnings from the investment are withdrawn. Annuity tax treatment differs significantly from that of retail mutual funds and other securities in taxable accounts (collectively, “non-tax advantaged investments”) in that all gains and investment income earned within the product are sheltered from tax until the contract owner surrenders or pledges his contract (except in certain cases involving “non-natural” contract owners). This ability to defer income tax is a major tax advantage of annuities over non-tax advantaged investments. Also, and with particular significance to the invention, in many annuity products, the contract owner can transfer account value between investment options without incurring a tax consequence. However, it should be noted that upon surrender or pledge of the contract, the owner's gain is taxed as ordinary income, in contrast to the treatment of non-tax advantaged investments, where the gain is generally taxed using the more favorable capital gains tax treatment. If a contract owner wishes to partially surrender the annuity, e.g., extract some amount of cash from his account value, these amounts will be taxed on a last in first out (LIFO) basis. As an example, if the contract owner had paid in $100,000, now has a contract account value of $300,000, and wishes to extract $50,000 in cash, he will be fully taxed on the $50,000, because the gain in the contract is $200,000 and that gain must be withdrawn first under the LIFO rules.

Life insurance products are familiar financial products that include a death benefit component. Certain life insurance products, such as whole life and universal life insurance products, also include a cash value accumulation component. As with an annuity contract, a life insurance policy's cash value grows on a tax-deferred basis. And as with many annuity contracts, many life insurance policies provide that the policy owner may transfer account value among investment options without any tax consequences; this advantage has particular significance in connection with the invention. The cash value can be borrowed or received upon termination of the policy, and can often be withdrawn with a corresponding reduction in the death benefit. Amounts borrowed, withdrawn, or received upon surrender are not taxed except to the extent such amounts exceed the policy owner's investment in the contract (sometimes referred to as “basis”).

There are a number of different ways of classifying insurance products. In one method, insurance products can be classified according to how premium payments are invested and how insurance benefits are determined. According to this method, insurance products can be divided into two general categories: fixed or general account products (“fixed insurance products”), and variable or separate account products (“variable insurance products”). In addition, there is a hybrid type of product that combines both fixed and variable elements (“combination insurance products”).

In the case of fixed insurance products, the insurance company guarantees certain benefits. More specifically with respect to fixed deferred annuities (see paragraph 10 for discussion of immediate vs. deferred annuities), the insurance company generally guarantees a certain rate of interest for a period of time on premiums paid in the accumulation phase (see paragraph 11). Once the guarantee period is over, a new interest rate is set for the next period. This guarantee of both interest and principal makes fixed annuities somewhat similar to Certificates of Deposit (CDs) purchased from a bank. During the income phase, the contract guarantees fixed income payments based on the contract's account value at the start of the income phase and an annuity interest rate that will be not less than a rate guaranteed in the contract. Similarly, with respect to fixed life insurance, the policy typically guarantees a fixed death benefit and cash values at certain points based on the scheduled premium payments. Fixed insurance products are sometimes also called general account products because the issuing insurance company receives premiums into and makes guaranteed payments from its general account. The insurance company will usually invest the assets in its general account conservatively with an emphasis on fixed income assets such as high-grade corporate bonds. Accordingly, benefits in fixed insurance products tend to be relatively modest.

If a prospective contract or policy owner desires the potential for greater benefits than those afforded by the conservative investing inherent in fixed insurance products, he may purchase a variable annuity contract or a variable life policy. In the case of variable insurance products, the insurance company generally does not guarantee the product's benefits, nor its account or cash values. Instead, the benefits and values will be wholly or largely determined by the investment performance of the assets underlying the product. With variable insurance products the insurance company makes available to the owner a number of investment options in a separate account, sometimes called the variable account. The investment options are usually called sub-accounts. The contract owner or policy owner chooses from among these sub-accounts to invest his premiums. The sub-accounts in turn generally invest in mutual funds, which are generally open-end management investment companies regulated pursuant to the Investment Company Act of 1940, and managed by registered investment advisers. The typical investment options are a range of mutual funds that generally can be characterized using the common labels of fund types, such as “growth funds” or “value funds” or “balanced funds.” In addition, funds can be characterized as “equity,” “fixed income,” and “cash” or “money market.” These mutual funds may invest in a number of different kinds of securities, including equities, which traditionally have afforded a higher return than fixed income securities. Account value and income payments in a variable annuity will be determined by the performance of the underlying mutual funds. Similarly, with respect to variable life insurance, the policy's cash and surrender values and death benefit will be determined by the performance of the underlying mutual funds. Thus, variable insurance products are sometimes called separate account products because the issuing insurance company receives premiums into its separate account and invests them according to instructions received by the product's owner, and the insurance company makes benefit payments from the separate account based on the product owner's account value.

A combination insurance product is an annuity contract or life insurance policy that provides the owner with the opportunity to split his insurance premiums between a fixed element and a variable element. As with a fixed insurance product, the fixed element of the product guarantees both principal and interest and benefits, much like a fixed annuity. As with a variable insurance product, the variable element of the product does not guarantee principal or interest or benefits or account or account values, but does allow the contract owner to select potentially higher risk/higher reward investment options in the variable sub-accounts. The combination insurance product is desirable to provide a guarantee to the owner that his capital will be preserved (or a desired portion thereof), while still giving a variety of market-dependent investment options providing the possibility of enhanced investment returns, with the efficiency of offering all of this in one product.

In addition to their classification according to the manner of investments (fixed or variable), annuities can also be classified according to when their periodic income payments begin. “Immediate annuities” are contracts generally funded by a single premium payment wherein the periodic income payments to the owner or beneficiary must begin within one year of the issue date of the contract; in most cases income payments begin within a month of the issue date. “Deferred annuities” are contracts wherein the periodic income payments will not commence until some time after a year has passed; typically they commence by reference to the owner or annuitant attaining a specified age, e.g. 65. Until that specified date (the “income date”), the deferred annuity is in the accumulation phase. In that phase, one or more premium payments may be made and account value grows on a tax-deferred basis. Thus for example, a person may fund a deferred annuity and, upon retirement of that person, the issuing insurance company pays the retiree a series of periodic income payments. Such products are desirable because the earnings remain invested and grow on a tax-deferred basis; income tax is incurred only when the periodic income payments are received, typically when the retiree is in a lower tax bracket. Some annuity products allow the annuity recipient to receive the annuity funds as a lump sum.

As mentioned above, annuity products may be funded by way of a single payment, or by way of multiple payments (“flexible payment products”). The same is also true of life insurance policies. However, traditional life insurance products that involve multiple premium payments are actually scheduled premium products. In other words, in order to keep the policy in force the policy owner must make premium payments of a pre-determined amount at scheduled points in time. More recently, “universal” life insurance products have been developed allowing for some flexibility in the payment of premiums. Thus, insurance products can be further classified as single payment or flexible payment or scheduled payment products.

Annuity contracts typically offer several different methods of periodic payments in the payout phase, regardless of whether such contracts are immediate or deferred. In almost all cases, an annuity contract will offer a life annuity, under which the annuity beneficiary is paid from the income date until death of the annuitant (who is usually but not always the same person as the annuity beneficiary). These contracts are administered in the same way as a life insurance contract, using life expectancy tables, so that the insurance company that sells the annuity is assured of a profit on the annuity business over a sufficient customer population—assuming its mortality assumptions are accurate. Annuities in their payout phase can provide fixed, variable, or a combination of fixed and variable annuity payments.

The payout phase is often for the life of the annuitant who is usually, but not always, the annuity owner. Annuity contracts will also often provide for payout phases based on the life of the annuitant and a second person (such as the annuitant's spouse). They may also provide for periodic payments for a specific period of time, such as 15 years, or for the longer of the annuitant's life or a specific period of time. In annuity products where a life contingent periodic payment option is elected, the annuity issuer bears the risk that the annuitant will live longer than predicted. The contract owner bears the risk of dying sooner than expected

In the field of financial products, and hence by extension in the field of variable insurance products, an investment strategy known as asset allocation has been developed. Asset allocation generally involves strategically investing one's available funds among several or more asset classes (equity securities, fixed income securities, cash or money market) in order to reduce the investment risk inherent in investing in one asset class, while potentially helping to enhance investment returns. Generally, the process of asset allocation in a variable insurance product includes a contract or policy owner's attempt to determine his investment profile by assessing his (a) level of risk tolerance/risk aversion, (b) investment time horizon, and (c) investment goals. Often, this process can be accomplished by way of a risk profile questionnaire that can be scored with a result that indicates the owner's investment profile. After the owner's profile has been determined, he has the opportunity to invest in asset classes (represented by sub-accounts investing in mutual funds) within the variable insurance product according to what the profile would suggest.

In the field of variable insurance products, a program has been developed to aid the owners of variable insurance products in the strategy known as asset allocation. In that program, the insurance company, or an investment advisory firm or individual with which the insurance company or contract or policy owner contracts (“advisor”), creates asset allocation models that correspond to named investor profiles. In these models, the model creator indicates the exact percentage of the owner's account value that should be invested in asset classes (represented by sub-accounts investing in corresponding mutual funds). Some models might have higher levels of equity investments indicating a profile with a long investment time horizon and/or above average risk tolerance, and others might have lower levels of equity investments and higher levels of fixed income investments and/or cash investments indicating a profile with a shorter investment time horizon and/or an above average risk aversion. Generally, there may be 3 to 8 such asset allocation models corresponding to the named investment profiles (e.g., Asset Preservation, Strategic Income, Income and Growth, Conservative Growth, Moderate Growth, Aggressive Growth). The profile suggests the appropriate model the owner may wish to select, and the model then dictates the allocation of the owner's account value among appropriate asset classes (represented by sub-accounts investing in corresponding mutual funds) within the product.

Often, asset allocation programs offered by insurance companies in connection with variable insurance products will provide for a periodic rebalancing of the investments within an owner's selected model to the percentages indicated in the model. This is because the reinvestment of dividends and income and the changes in investments' valuation will have caused certain investments to grow to exceed the recommended percentages, while others will have suffered losses causing them to be lower than the recommended percentages. Often, this rebalancing is done quarterly on an automatic basis with no initiation or intervention needed by the owner.

Generally, the creator of the models will monitor the factors that it used to devise each model with an eye to revising models. Such factors may include the general economy, trends within industries or sectors in the economy, key indicators of the issuers that are the underlying securities for the mutual funds which the sub-accounts invest in, etc. The asset allocation program offered by the insurance company may include a scheduled periodic review and revision of the models by the insurance company or adviser, with the insurance company thereafter making the necessary reallocations to bring each owner's contract in line with the new recommended components and percentages of his chosen model. The program may also include the ability for the insurance company or adviser to change the components and percentages of the models between the scheduled dates in the event of extraordinary circumstances; again, the insurance company would then align each owner's contract accordingly.

In the field of financial products, and hence by extension in the field of variable insurance products, a strategy for investing has been developed based on the theory that some securities may be characterized as having certain traits in common. For example, some believe that certain securities can be characterized as “growth” securities, while other securities may be characterized as “value” securities. Generally, growth securities will be those that are perceived as offering the best potential for long-term capital gains, they generally offer little or no dividends, and they may have a higher risk profile. Generally, value securities will be those that may be undervalued according to formulas developed by analysts. Competing theories, generally supported by empirical evidence, will suggest that staying invested in one or the other type of security is likely to lead to the best long term investment results, and/or that one or the other type is the best investment value at a particular time. These strategies for investing based on the characterization of securities in certain types might be called “style-driven” investing.

In the field of variable insurance products, insurance companies have provided support for owners who adhere to a style-driven investment strategy by developing models that correspond to various styles of investing. In these models, the insurance company, or an adviser, indicates the exact percentage of the owner's account value that should be invested in asset classes (represented by sub-accounts investing in mutual funds) that are considered to be investments corresponding to the preferred style.

As with asset allocation programs, style-driven model programs offered by insurance companies in connection with variable insurance products will generally provide for a periodic rebalancing of the investments within an owner's model to the percentages indicated in the model. This is because the reinvestment of dividends and income and the changes in investments' valuation will have caused certain investments to grow to exceed the recommended percentages, while others will have suffered losses causing them to be lower than the recommended percentages. Often, this rebalancing is done quarterly on an automatic basis with no initiation or intervention needed by the owner.

As with asset allocation models, generally, the insurance company or an advisor will monitor the factors that it used to devise each style-driven model with an eye to revising models. Such factors may include the general economy, trends within industries or sectors in the economy, key indicators of the issuers of the underlying securities, etc. The program offered by the insurance company may include a scheduled periodic review and revision of the models by the insurance company or the adviser, with the insurance company making the necessary reallocations to bring each owner's contract in line with the new recommended components and percentages of the model. The program may also include the ability for the insurance company or adviser to change the components and percentages of the models between the scheduled dates in the event of extraordinary circumstances; again, the insurance company would then align each owner's contract accordingly.

### SUMMARY OF THE INVENTION

It is an object of the invention to provide a tax-advantaged investment product with the possibility of substantial investment returns in the form of a variable annuity or variable life insurance product, or a combination variable annuity or variable life insurance product, that is designed to provide the owner with an alternative investment strategy involving rotation of investment allocation among investments representing specific sectors of the economy in an effort to optimize investment returns.

In accordance with one embodiment of the invention, a method of administering a variable annuity or life insurance product (or combination product) comprises steps in which an insurance company receives a premium payment for the product and allocates at least a portion of the premium payment to a variable account in the form of one or more sector investment options (represented by sub-accounts investing in mutual funds) pursuant to an asset allocation model or style-driven model selected by the contract or policy owner. (The same step may be repeated for subsequent premium payments, or may be initiated at any point after the initial premium payment, by using the contracts or policy's account value.). In one preferred embodiment involving a variable insurance product, the insurance company allocates a second portion of the premium payment to a fixed income investment option. The insurance company, or an investment adviser selected by the insurance company or contract or policy owner will periodically review the models and determine if alternate sector investment options and/or changing the weighting of existing recommended sector percentages provide a greater potential investment return and/or less potential risk given the current state of the economic cycle and other considerations pursuant to the sector selection rotation investment methodology. If so, the insurance company or adviser, as appropriate, will revise the asset allocation or style-driven models and the insurance company will reallocate the appropriate amount of account value among the various sector investment options (represented by sub-accounts investing in mutual funds) for each owner participating in an affected model.

Other objects, aspects and features of the invention in addition to those mentioned above will be pointed out in or will be understood from the following detailed description in conjunction with the drawings.

### BRIEF DESCRIPTION OF THE DRAWINGS

FIG. 1 is a flowchart showing the steps of one embodiment of a method in accordance with the invention.

FIG. 2 is a flowchart showing the steps of one life insurance embodiment of a method in accordance with the invention.

FIG. 3 is a flowchart showing the steps of one annuity embodiment of a method in accordance with the invention.

FIG. 4 is a flowchart showing implementation of the invention in one software embodiment.

FIG. 5 is a flowchart showing typical sector rotation within a complete economic cycle.

### DETAILED DESCRIPTION OF THE DRAWINGS

The present invention provides a combination of the investment methodology known as sector rotation with tax-advantaged investment products, particularly, variable annuity and variable life insurance products and combination insurance products. The sector rotation methodology is implemented through purchase of appropriate funds (by way of the product's sub-accounts), such as equity mutual funds, exchange traded funds, or index funds which are available through such variable insurance products or combination insurance products. One commercial implementation of the concept of the invention is described in the “Choice Prospectus” for “Combination Fixed and Variable Annuity” issued by Sage Life Assurance of America, Inc., and dated May 1, 2002, the disclosure of which is hereby incorporated by reference.

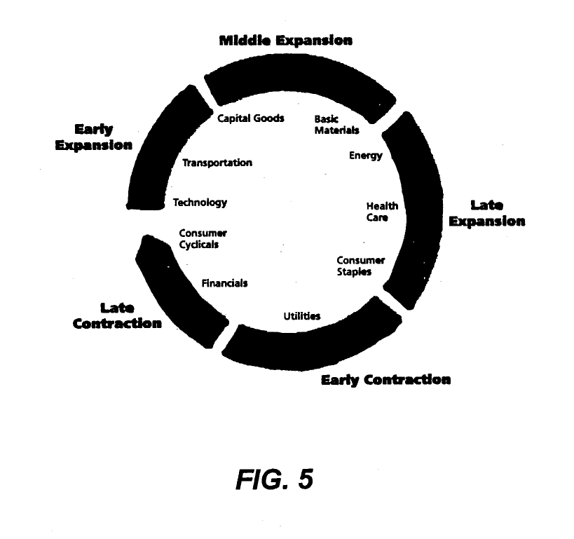

Sector rotation methodology is an active asset management strategy that increases investment in equities of companies in sectors of the economy at a time when those sectors are expected to have growing revenue or profitability. The sector rotation methodology is based on the expectation that the economy follows a fairly predictable business cycle, with different sectors showing increasing business activity in different periods of the business cycle. FIG. 5 illustrates the typical path of economic activity as it rotates among sectors in a typical economic cycle. Where a sector is increasing in activity, and revenue and profits are increasing for companies in that sector, the value of stock equities for companies in that sector will generally increase. This provides a methodology for the investor to seek to predict and profit from the change in business activity among different sectors over the course of the business cycle. In addition to this broad notion of investment returns tied to the business cycle, there are often broad trends in particular industries that indicate profitability (or losses) for the entire sector, and a sector rotation investor is sensitive to such trends, and the change in value of equities arising from such trends.

Accordingly, sector investing follows a “top-down” investment approach that begins with the economic outlook and assesses which sectors are likely to benefit from expected changes in the economy. This strategy focuses on (a) the forecast for key economic variables, such as interest rates, inflation, and consumer spending; (b) how different sectors performed in similar cycles in the past; and (c) the sectors likely to thrive in the forecast environment over the next 12 to 18 months.

Sector investors therefore “rotate” among sectors in order to increase investment exposure to the expected best performing sectors and reduce exposure to the expected worse performing sectors. However, an investor's investment profile may suggest that other factors may also need to be taken into consideration and require supplementing or fine-tuning the straight sector rotation investing approach. For example, some investors' profiles might suggest that income is equally or perhaps even more important than capital gains, while others might suggest that capital preservation is the pre-eminent consideration. Carefully differentiated asset allocation models and style-driven models may therefore useful to the investor who also wishes to participate in sector investing relying on the sector rotation methodology.

In particular, while the stock market is composed of thousands of individual companies in many different industries, these industries can be categorized into broad sectors of the economy. As an example, Standard & Poor's divides its S & P 500® stocks into 10 sectors: energy; materials; industrials; consumer discretionary; consumer staples; health care; financials; information technology; telecommunications services; and utilities. The sector rotation methodology is based on the premise that no matter what is happening in the overall market, there are always some sectors that are providing greater return on equity investments than others (or, as may have been the case in the recent broad market decline, there are always some sectors wherein negative returns are not as steep as in other sectors).

The sector rotation methodology has a benefit of a potential for greater profitability than an investment, such as an index fund, in the broad market. But the methodology also carries a greater risk, as is typical of any investment strategy that focuses on specific areas of the equity markets.

In the present invention, the sector rotation investments are implemented as investments in one or more sub-accounts, each in turn investing in a corresponding equity mutual fund, exchange traded fund, or index fund, all pursuant to a model devised by the insurance company or an adviser the insurance company or the contract or policy owner has contracted with. Mutual funds are familiar investment vehicles by which investors pool their money to create a fund which is managed by an investment adviser and regulated pursuant to the Investment Company Act of 1940 and the rules promulgated thereunder. Owners of mutual fund shares generally have the right to redeem their investment on any business day at the end-of-the-day net asset value per share of the fund. Index funds are a form of mutual fund which invest in stocks making up a specific index. The S & P 500 Composite Stock Index® and Dow Jones Industrial Average are two of the most well known indexes. In the case of sector investing, more specialized indexes such as the Dow Jones Transportation Average, or the Dow Jones Utility Average, or the Nasdaq Telecommunications Index, may be used. Exchange traded funds, or ETFs, are securities that combine essential elements of individual stocks and index funds. Like stocks, ETFs are traded on the major U.S. stock exchanges and can be bought and sold through any brokerage account at any time during normal trading hours. Like index funds, ETFs are pools of securities that track specific market indices or sectors at a very low cost. ETFs give investors the opportunity to buy or sell an interest in an entire portfolio in a single transaction. ETFs provide the advantages of traditional index mutual funds, including low annual fees, with the liquidity and ease of execution of stocks that are repriced throughout the trading day.

The model may be an asset allocation model, in which case it is likely only a portion of the contract's or policy's account value will be invested in sectors, as certain asset classes such as fixed income funds and cash/money market funds do not typically lend themselves to classification as sector funds. Or the model may be a style-driven model, in which case it is possible that all of the account value is invested in sectors.

In one preferred embodiment, the sector rotation investment methodology is implemented in a “fund of funds.” In such a case, the owner of the variable insurance or combination product invests the product's account value in a single mutual fund, which in turn invests in other funds representing specific sectors. The “fund of funds” concept can be customized by fund investment advisers such that individual fund of funds are designed to be appropriate for investors interested in style-driven investments.

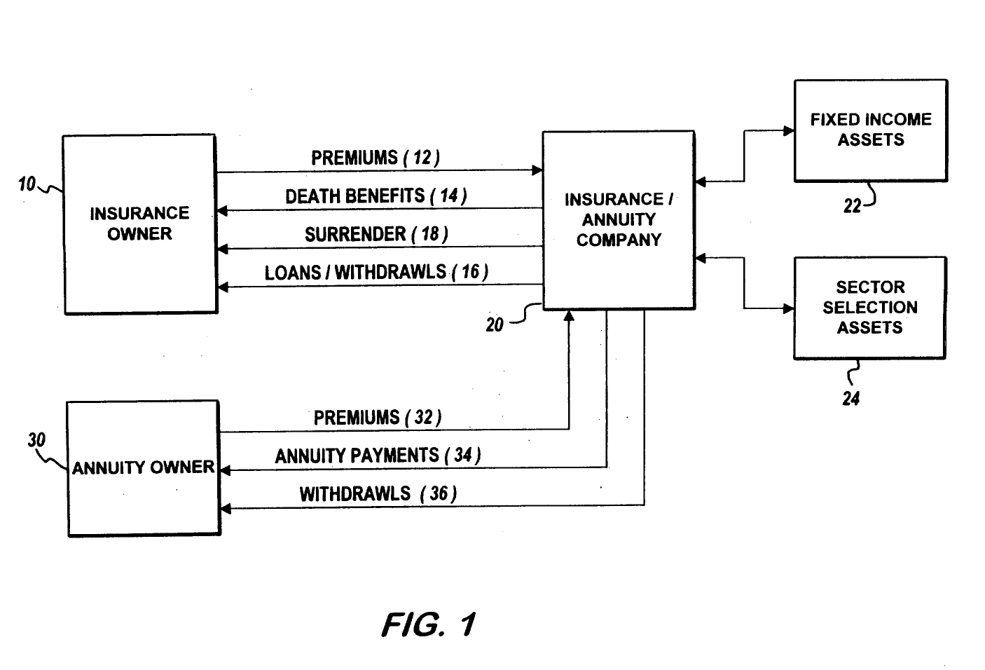

Referring now in detail to the drawings wherein like elements are designated by the same reference to numerals throughout, there are illustrated in FIG. 1 both a life insurance policy as well as an annuity contract according to the preferred embodiment of the present invention. A life insurance policy owner 10 pays premiums 12 to an insurance company 20. Upon the death of the insured, the insurance company 20 pays a death benefit 14 under the life insurance policy to the beneficiary named by the owner 10. The owner 10 can also remove money from the life insurance policy through withdrawals or loans 16, or surrender 18 of the policy, wherein the policy is terminated and the account value, less any surrender and other payable charges, is returned to the owner 10. Similarly, an annuity contract owner 30 pays premiums 32 to the insurance company 20. Owner 30 receives annuity payments 34 beginning at the specified income date, or may be permitted withdrawals 36.

In the present method, at least some of the account value of the insurance contract may be invested in an asset allocation or style-driven model created with the intent to use the sector selection rotation investment methodology. As this creates a potential risk of loss of capital, it is possible that in a combination insurance product that the owner will make both fixed income investments 22 as well as sector selection investments 24 related to the owner's account value.

The present invention adds the unique feature of sector selection assets, and the sector rotation methodology, 24 to the life insurance cash value or annuity account value in the context of professionally designed models which are geared towards the investor's specific investment profile. The value of such assets for the owner will depend on sector performance.

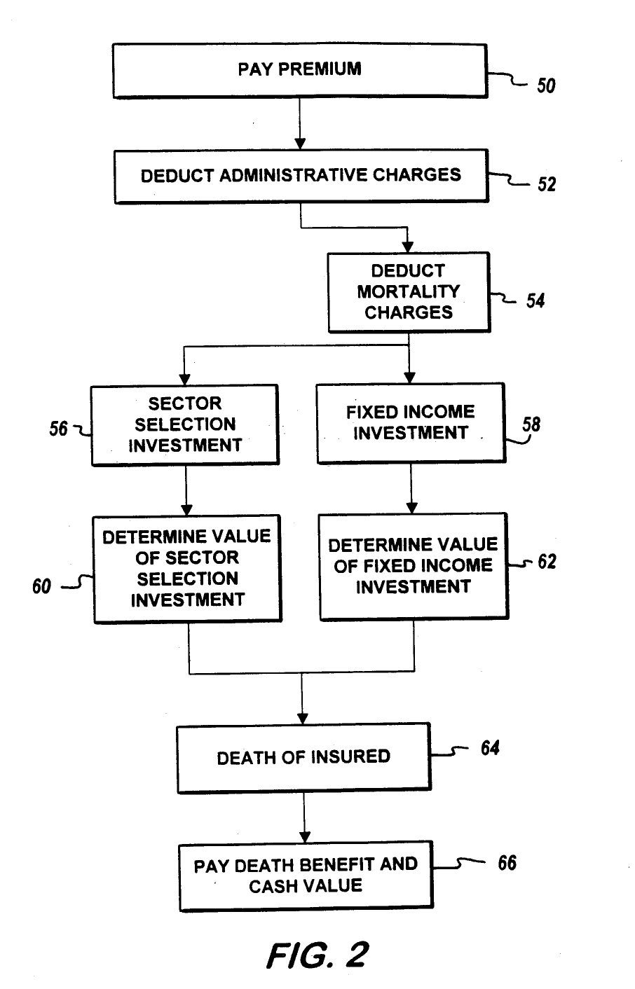

FIG. 2 is a block flow diagram illustrating steps involved in a life insurance product in accordance with one embodiment of the invention. Life insurance premiums are paid at step 50. Administrative charges are deducted at step 52. Mortality charges for the cost of the death benefit are deducted at step 54. The balance of the premium is allocated to an asset allocation or style-driven model created with the intent to use the sector selection rotation investment methodology 56, and, if desired, and if the product is a combination insurance product, a portion is also allocated to a fixed income investment 58. The value of the sector selection rotation investment is periodically determined in step 60, typically every business day that the stock markets are open for business. The value of the fixed income investment (if chosen by the policy owner in a combination insurance product) will also require periodic determination in step 62, and will depend on the interest rate of the fixed income investment of the policy. Such investment will steadily increase and will not fluctuate in value as will the sector selection investment. The interest rate of the fixed income investment will be guaranteed for a specific period. At the end of that period, the policy typically provides that the owner may elect to allow the accrued balance to roll over for the same period at the then-announced guaranteed interest rate, or select a new guarantee period with its then current interest rate, or reallocate such account value to the variable separate account. The premiums may be paid on a monthly, quarterly, yearly or some other basis. (The policy might be a single premium policy, in which case only one premium payment is made.) The cash values may be adjusted on a daily, weekly, monthly or yearly basis, or some other basis. Upon death 64 of the insured, the policy is terminated, and the death benefit is paid 66 to the policy owner.

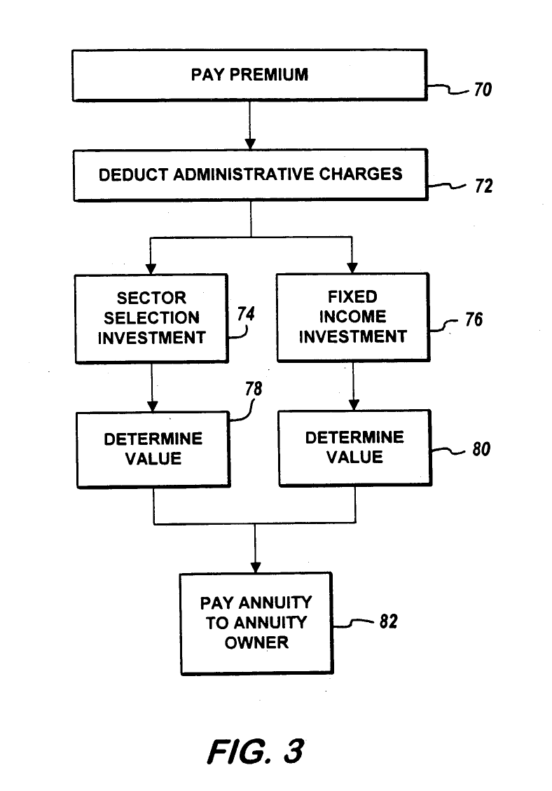

For an annuity contract, premiums are paid and the account values are calculated in a manner similar to the life insurance policy. FIG. 3 is a block flow diagram illustrating steps involved in an annuity product in accordance with one embodiment of the invention. Annuity premiums are paid at step 70. Certain administrative charges may be deducted before investment of the balance of the premium at step 72. The balance of the premium is allocated to an asset allocation or style-driven model designed with the intent to use the sector selection rotation investment methodology 74, and, if desired, and if the contract is a combination annuity contract, a portion is also allocated to a fixed income investment 76. Thereafter, other charges are deducted daily, weekly, monthly, or yearly, and are typically a percentage of one or more aspects of the contract's values (e.g., its variable account value, or its fixed account value, or its combined account value). The value of the sector selection investment is periodically determined in step 78, typically, every business day that the stock markets are open for business. The value of the fixed income investment (if chosen by the policy owner) will also require periodic determination in step 80, and will depend on the interest rate of the fixed income investment of the contract. Such investment will steadily increase in value and will not fluctuate as will the sector selection investment. The interest rate of the fixed income investment will be guaranteed for a specific period. At the end of that period, the contract typically provides that the owner may elect to allow the accrued balance to roll over for the same period at the then current guaranteed interest rate, or select a new guarantee period with its then current interest rate, or reallocate such account value to the variable account. The premiums may be paid on a single payment or a flexible payment basis. The account values may be adjusted on a daily, weekly, monthly or yearly basis, or some other basis. Upon reaching the income date, periodic income payments 82 are made to the annuity beneficiary based on the account value at that time.

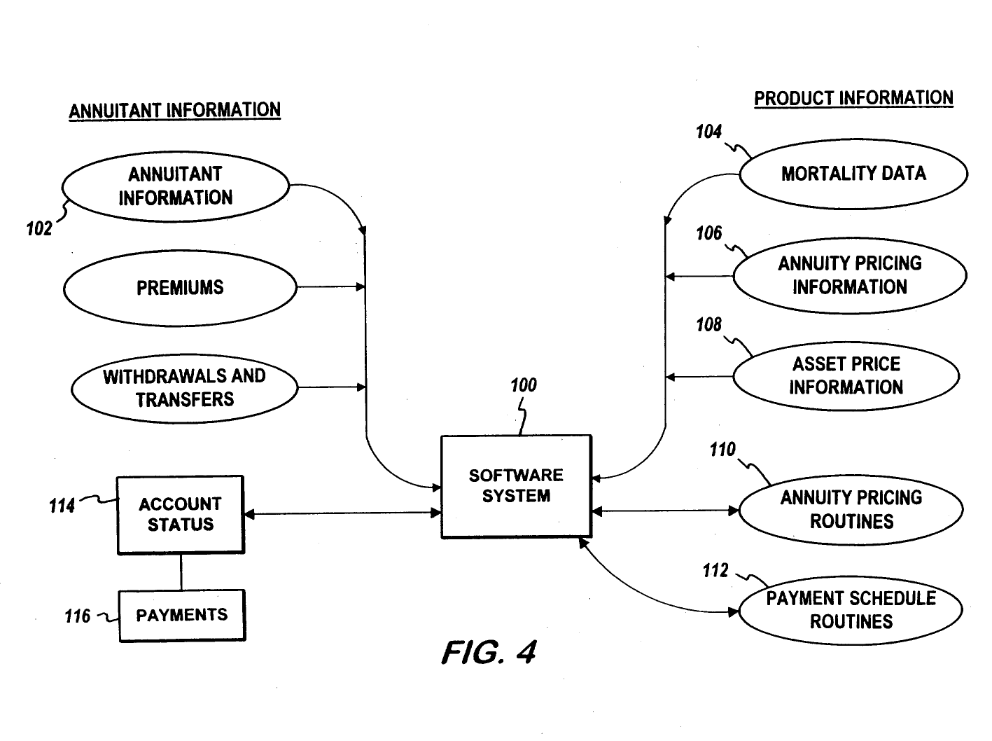

Referring to FIG. 4, software system 100 is preferably implemented as a main program of a software program that comprises various routines or modules to perform the functions of the present invention described herein. Appropriate software structures may be implemented by persons of ordinary skill in the art to implement the present invention. The invention is not limited to the embodiments described herein.

The functions of software system 100 may be implemented in special purpose hardware or in a general or special purpose computer with appropriate operating system and memory storage and input/output devices. In a preferred embodiment the functions of system 100 are controlled by software instructions which direct a computer or other data processing apparatus to receive inputs, perform computations, transmit data internally, transmit outputs and effectuate the receipt and transfer of funds as described herein. The present invention provides a system for managing annuities and distribution of annuity and life insurance payments, comprising: (1) data storage for storing product information related to: (a) annuity pricing information for determining pricing interest rates for said annuities, (b) asset price information for determining actual rates of returns for assets underlying said annuities, (c) mortality data for each annuitant of said annuities; and (2) data processing means for (a) deriving pricing interest rates from said annuity pricing information, (b) determining actual rates of returns for said underlying assets of said annuities from said asset price information, (c) computing actuarial present values and fund reserves from said pricing interest rates and said mortality data, (d) computing investment performance factors from said pricing interest rates and said actual rates of return, (e) computing interest adjustment factors from said actuarial present values, and (f) determining payment progressions for said annuities from said investment performance factors and said interest adjustment factors. Data storage may be provided by any suitable storage medium that is accessible by the data processor used to implement the invention. Examples include, random access memory, magnetic tape, magnetic disk, or optical storage media.

Software system 100 receives annuity contract information 112 regarding new annuity contracts. This information will typically include information about the contract owner (and annuitant, if that person is not the contract owner) that is pertinent to mortality, (e.g., age), the type or types of annuities selected, and the contract owner's investment choices. For example, the choice may be a combination annuity involving a fixed component and a variable component, each with its corresponding periodic income payment options, with each different component supported by different underlying asset classes, including a sector investment asset class. Software system 100 also receives transfer requests from existing annuity owners. Annuitant/contract owner information 102 is input into a memory accessible by software system 100, using any suitable input device, e.g. by keyboard entry of data into a database.

Software system 100 also receives product information such as mortality data 104, used in calculation of life insurance premiums, and annuity pricing information 106. Annuity pricing information 104 includes fixed income investment information such as market interest rates used to price annuities. These interest rates may be tied to an objective market rate such as treasury rates, a corporate bond rate or other objective rate. The rates used to price annuities may be related to an objective market interest rate by a constant offset, a multiplicative factor, an exponential function, or any other suitable relationship. Annuity pricing information 104 will also include sector selection investment annuity pricing information. Software system 100 also receives asset price information 108 which comprises the net asset values of the underlying assets for each investment subaccount. Asset price information 108 is used by system 100 to determine the investment performance of the assets underlying the annuity funds.

Software system 100 uses annuity pricing information 106 and mortality data 104 to determine the market value of annuities based on such information using annuity pricing routines 110. Software system 100 also uses the information to develop both projected, and actual annuity payment schedules using payment schedule routines 112. Software system 100 manages the calculation of an annuity owner's account status 114 and payments 116.

The present invention provides a method of administering a variable annuity or life insurance product in which an insurance company receives a premium payment for a variable annuity or life insurance product or a combination insurance product and allocates at least a portion of the premium payment to an asset allocation or style-driven model created with the intent to use the sector selection investment methodology.

In the preferred embodiment, the insurance company allocates a second portion of the premium payment to a fixed income asset investment option of a combination insurance product.

The insurance company, or an investment adviser selected by the insurance company or the contract or policy owner will periodically review the asset allocation or style-driven models and determine if alternate sector investment options and/or changing the weighting of existing recommended sector percentages provide a greater potential investment return or lower potential risk, given the current state of the economic cycle and other considerations pursuant to the sector selection rotation investment methodology. When a change is made to a model, the insurance company will, as to each contract or policy owner who has selected the model, reallocate the appropriate amount of account value among the various sector investment options In the preferred embodiment, the contract or policy owner will also have the option of transferring account value from the sector investment options to the fixed income asset investment options, and visa-versa.

It is to be appreciated that the foregoing is illustrative and not limiting of the invention, and that other modifications of the invention may be chosen by persons of ordinary skill in the art, all within the scope of the invention as claimed below.

What is claimed is:

1. A method of administering a variable annuity or life insurance product, comprising the steps of:
an insurance company receiving premium payments for said variable annuity or life insurance product of a contract or policy owner;
said insurance company allocating at least a portion of an account value derived from said premium payments to an asset allocation or style-driven model, selected by the owner, and created by the insurance company or an adviser selected by it or the contract or policy owner, which model uses the sector selection rotation investment methodology;
said insurance company or an adviser selected by it or the contract or policy owner periodically reviewing said asset allocation or style-driven models and determining whether alternate sector investment options should be included and/or whether changing the weighting of existing recommended sector percentages provides a greater potential investment return or lower potential risk for said models;
said insurance company reallocating the appropriate amount of account value of all contract or policy owners who have selected the affected model(s) to the components and percentages of sector investment options recommended in the model by the creator of the model(s).

2. A method in accordance with claim 1, wherein said steps of reallocating said account value are initiated solely by a financial adviser to said insurance company.

3. A method in accordance with claim 1, wherein said steps of reallocating said account value are initiated solely by said contract or policy owner.

4. A method in accordance with claim 1, wherein said steps of reallocating said account value are initiated either by a financial adviser to said insurance company or by said contract or policy owner.

5. A method in accordance with claim 1, wherein some portion of said premium payment may be allocated to a fixed income asset investment option.

6. A method in accordance with claim 1, further comprising a fund of funds in which said sector investment options are available as funds within said fund of funds.

7. A method of administering a combination insurance product, comprising the steps of:
an insurance company receiving a premium payment for said combination insurance product of a contract or policy owner;
said insurance company allocating at least a portion of said premium payment to an asset allocation or style-driven model selected by the owner and created by the insurance company or an adviser selected by it or the contract or policy owner, with the intent to use the sector selection rotation investment methodology;
said insurance company or an adviser selected by it or the contract or policy owner periodically reviewing said asset allocation or style-driven model and determining whether alternate sector investment options should be included and/or whether changing the weighting of existing recommended sector percentages provides a greater potential investment return or lower potential risk;
said insurance company reallocating the appropriate amount of account value of all contract or policy owners who have selected the affected model(s) to the components and percentages of sector investment options recommended by the creator of said model(s).

8. A method in accordance with claim 7, wherein said steps of withdrawing and transferring said allocated portion of said premium payment are initiated solely by a financial adviser to said insurance company.

9. A method in accordance with claim 7, wherein said steps of reallocating said account value are initiated solely by said contract or policy owner.

10. A method in accordance with claim 7, wherein said steps of reallocating said account value are initiated either by a financial adviser to said insurance company or by said contract or policy owner.

11. A method in accordance with claim 7, wherein said policyholder may transfer allocated premium payments between said asset allocation or style-driven model and said fixed income asset investment options, or vice versa.

12. A method in accordance with claim 7, further comprising a fund of funds in which said sector investment options are available as funds within said fund of funds.

13. A software system comprising:
data processing apparatus;
means connected to said apparatus for inputting data and instructions to said apparatus;
said software system maintaining a plurality of user accounts, said software system allocating premium payments received for the benefit of a contract or policy owner to a user account,
said premium payments allocated to said user accounts being invested for the benefit of an owner of said user accounts;
at least some premium payment and/or account value allocated to at least one of said user accounts being invested in a sector investment option;
said software system transferring said allocated account value from said sector investment option to alternate sector investment options or to different weightings of sector investment options upon instruction by a system user.

14. A system in accordance with claim 13, wherein some account value allocated to user accounts may be invested in a fixed income asset investment option.
